(19) United States
(12) Patent Application Publication
(10) Pub. No.: US 2026/0355855 A1
(43) Pub. Date: Nov. 12, 2026

(54) Monitoring Device for Monitoring a Laser Machining Process, Laser Machining System, and Method of Monitoring a Laser Machining Process

(71) Applicant: Precitec GmbH & Co. KG, Gaggenau (DE)

(72) Inventors: Joachim Schwarz, Kleinandelfingen (CH); Rainer Kraft, Ettlingen (DE)

(73) Assignee: Precitec GmbH & Co. KG, Gaggenau (DE)

(21) Appl. No.: 19/670,596

(22) Filed: May 7, 2026

(30) Foreign Application Priority Data
May 8, 2025 (DE) 10 2025 117 607.8

(51) Int. Cl. B23K 26/03; B23K 26/082; B23K 26/70; H04N 23/12

(52) U.S. Cl. CPC B23K 26/032; B23K 26/082; B23K 26/702; H04N 23/12

(57) ABSTRACT

A monitoring device for monitoring a laser machining process, includes: an image sensor for capturing an image of a machining area of the laser machining process, the image sensor comprises an array of X × Y pixels and a mosaic filter, the X × Y pixels are grouped into N hyperspectral pixels by the mosaic filter, and a control device for monitoring the laser machining process based on sensor data from the image sensor. The control device is configured to: selecting at least one hyperspectral pixel based on a user input for at least one selected image area, reading out all pixels of the at least one selected hyperspectral pixel from the image sensor, and monitoring and/or controlling the laser machining process based on the read-out sensor data corresponding to the at least one selected image area.

### CROSS-REFERENCE TO RELATED APPLICATIONS

The present application claims priority to German Patent Application No. 10 2025 117 607.8 filed May 8, 2025, the contents of which are herein incorporated by reference.

### TECHNICAL FIELD

The present disclosure relates to a monitoring device for monitoring a laser machining process, a laser machining system comprising such a monitoring device, and a method of monitoring a laser machining process.

### BACKGROUND

In a laser machining system, also known as a laser machining plant, the laser beam emitted from a laser beam source or the end of a laser guide fiber is directed onto a workpiece to be machining using beam-guiding and focusing optics. The workpiece may, in particular, be a metallic workpiece. The machining may comprise laser welding or laser cutting. The laser machining system may comprise a laser machining head, such as a laser welding head or a laser cutting head, in which the optics are arranged. The laser machining process may, for example, comprise a laser welding process and a laser cutting process.

In order to ensure machining quality, it is important to continuously monitor the laser machining process. Monitoring is typically performed by sensing and evaluating optical process emissions generated during the laser machining process. The optical process emissions comprise laser radiation backscattered or reflected by the workpiece (so-called laser back reflection), radiation in the (near-)infrared wavelength range of light (so-called infrared wavelength range), e.g., thermal radiation, and radiation in the visible wavelength range of light, e.g., radiation from a plasma generated during machining. The optical process emissions may be referred to as process radiation or process beam.

The process radiation is typically sensed by photodiodes. The photodiodes may be part of a monitoring device arranged on the laser machining head. The process radiation may be coupled into the monitoring device via the laser machining head. In the monitoring device, the process radiation is split into partial beams, each with different wavelength ranges, by a beam splitter arrangement comprising one or more beam splitters with a wavelength-selective coating or by optical filters. The photodiodes each sense the intensity of a corresponding partial beam within the specified wavelength range and generate a corresponding sensor signal. The sensor signal corresponds to the (average) intensity of the respective wavelength range. Changes in the measured intensity with respect to reference data indicate errors that have occurred in the laser machining process. For monitoring, the sensor signal curves are compared, for example, with predefined envelope curves and/or threshold values, and an error is output when a sensor signal lies outside the envelope curves or exceeds or falls below a threshold value. Error detection may be optimized by simultaneously considering various wavelength ranges.

In laser machining processes, various areas on or near the workpiece that are of interest for monitoring may be defined. For example, in laser welding, various sub-areas of the machining area are of particular interest. The machining area encompasses the point where the laser beam is incident on the workpiece. At this point, the so-called keyhole (also known as a vapor capillary) is formed, which typically corresponds to or encompasses the "Tool Center Point" (TCP) of the laser machining system. The machining area may further comprise a melt pool surrounding the keyhole, in which the material of the workpiece is melted. Also of interest are areas in the vicinity of the melt pool, for example areas upstream and/or downstream of the melt pool or the keyhole, and/or areas lateral to or adjacent to the melt pool or keyhole. The process radiation emitted from the aforementioned areas reacts in different ways to changes and/or errors in the laser machining process. For example, a change in heat distribution in an upper sheet may be detected in laser welding processes with a gap between the upper and lower sheets compared to laser welding processes without a gap.

In the case of photodiode-based monitoring of the laser machining process, this information is partially lost because all signals from the sensed area of the workpiece surface are detected as a sum, thereby preventing spatially separated evaluation. This is because each photodiode integrates the sensed intensity across all wavelengths within its specific spectral sensitivity range. Photodiodes therefore offer no spatial resolution (resolution of location). Furthermore, their alignment is complex, since, when multiple diodes are used, they must be aligned to the same focal position.

On the one hand, camera-based monitoring devices allow for precise, spatially resolved imaging of the laser machining process or the workpiece surface. On the other hand, the high spatial resolution comes at the expense of the data acquisition rate or readout frequency. Minor errors and/or microdefects, particularly those with error sources with short duration or short time scale, are not detected. This limits error detection. Furthermore, each pixel integrates the intensity over the sensor’s entire wavelength range. There is no spectral resolution. Additionally, camera-based monitoring requires corresponding resources for sensing or capturing, processing, and storing very large amounts of data.

The use of hyperspectral cameras allows for frequency- or wavelength-resolved and spatially resolved monitoring, though only at a frame rate or readout frequency of typically less than 1 kHz.

Furthermore, the intensities at specific wavelengths or in specific wavelength ranges of the process radiation are often masked by influences that are not process-relevant. For example, the signals are subject to a negative offset due to contamination of the protective lenses. A change in the focal position caused by temperature changes in the optics and/or components of the laser machining head also influences the process radiation sensed by the monitoring device. However, these phenomena do not necessarily affect the quality of the laser machining process. Existing monitoring solutions ignore the fact that such signal-relevant influences are not induced by the laser machining process itself. Protective glass monitoring and temperature monitoring are decoupled from the monitoring of the laser machining process. Monitoring of protective glass, temperature, and focal position often requires one or more additional devices.

Existing monitoring solutions offer either high spatial resolution with image-based sensors or a high readout frequency with diode-based sensors. Hyperspectral sensors available on the market that provide both spectral and spatial resolution have only a low readout frequency due to the limitations with respect to the maximum possible frame rate.

### SUMMARY

It is therefore an object of the present disclosure to provide a monitoring device that allows improved or more precise monitoring of a laser machining process and improved or more precise detection of process errors.

It is an object of the present disclosure to provide a monitoring device that allows spatially resolved and wavelength-resolved monitoring of the laser machining process while simultaneously providing a high readout frequency.

It is an object of the present disclosure to provide a monitoring device that allows flexible monitoring and/or monitoring adaptable to various applications or types of errors.

It is an object of the present disclosure to provide a monitoring device that, in addition to monitoring the actual laser machining process, also allows monitoring of one or more optical elements and/or components of a laser machining head and/or the focal position of a laser beam without additional devices.

It is also an object of the present disclosure to provide a laser machining system comprising such a monitoring device and a corresponding method of monitoring a laser machining process.

At least one of these objects is achieved by the present disclosure.

The present disclosure is based on the basic idea of using an image sensor with X × Y pixels and a mosaic filter, wherein the X × Y pixels are grouped into N hyperspectral pixels by the mosaic filter. For monitoring a laser machining process, one or more of the hyperspectral pixels are selected according to an image area selected by a user. During the laser machining process, the pixels of the selected hyperspectral pixel(s) are read out and the monitoring or closed-loop control of the laser machining process is performed (exclusively) based on the read-out sensor data, i.e., corresponding to the selected image area.

Since hyperspectral pixels are selected from the set of all hyperspectral pixels of the image sensor, the hyperspectral pixels (or pixels thereof) can consequently be read out at a resulting readout frequency that is higher than the nominal readout frequency of the image sensor. Here, the nominal readout frequency f₀ of the image sensor refers to the maximum readout frequency available for reading out all X × Y pixels. The resulting readout frequency fᵤ of the image sensor is obtained when reading out a smaller number u of pixels from the at least one selected hyperspectral pixel (u < X × Y) at the maximum readout frequency, i.e., fᵤ=(X × Y × f₀)/u. At the same time, spatially resolved observation of the laser machining process is made possible. Furthermore, by using pixels grouped into hyperspectral pixels, it is possible to sense the intensity of the process radiation with wavelength resolution over a wide wavelength range. This allows, in particular, for individual photodiodes, which cannot be placed arbitrarily or flexibly, cannot capture a complete image of the machining area, and lack spatial resolution, to be replaced. Furthermore, the monitoring device according to the present disclosure eliminates the need for photodiode alignment. Additionally, the disadvantages of previous solutions using cameras or hyperspectral cameras are overcome.

According to a first aspect of the present disclosure, a monitoring device for monitoring a laser machining process is provided, said monitoring device comprising: an image sensor for acquiring an image of a machining area of the laser machining process, wherein the image sensor comprises a (two-dimensional) array of X × Y pixels and a mosaic filter grouping the X × Y pixels into N hyperspectral pixels, and a control device for monitoring the laser machining process based on sensor data from the image sensor, wherein the control device is configured to: select at least one hyperspectral pixel based on user input for at least one selected image area, read out all pixels of the at least one selected hyperspectral pixel, and monitor and/or control the laser machining process based on the read-out sensor data, in particular corresponding to the at least one selected image area.

According to a second aspect of the present disclosure, a laser machining system for performing a laser machining process on a workpiece by a laser beam is provided, said laser machining system comprising: a laser machining head for radiating the laser beam onto the workpiece, a control unit for performing the laser machining process and/or for controlling the laser machining head, and a monitoring device for monitoring the laser machining process in accordance with one of the aspects and embodiments described herein.

According to a third aspect of the present disclosure, a method of monitoring a laser machining process using a monitoring device is provided. The method comprises the steps of: selecting at least one hyperspectral pixel based on user input for at least one selected image area, reading out all pixels of the at least one selected hyperspectral pixel, and monitoring and/or controlling the laser machining process based on the read-out sensor data, in particular corresponding to the at least one selected image area. The monitoring device may be a monitoring device for monitoring the laser machining process in accordance with one of the aspects and embodiments described herein. The monitoring device may comprise an image sensor for acquiring an image of a machining area of the laser machining process, wherein the image sensor comprises a (two-dimensional) array of X × Y pixels and a mosaic filter grouping the X × Y pixels into N hyperspectral pixels.

The aspects of the present disclosure may include one or more of the following optional features:

The control device of the monitoring device may be integrated into the control unit of the laser machining system or be a part thereof. In order to monitor the laser machining process, the control device may be configured to output a monitoring signal based on the read-out sensor data, e.g., to a user or to the control unit. In order to perform closed-loop control of the laser machining process, the control device, particularly as part of the control unit, may adjust or output control signals to components of the laser machining head or the laser machining system (e.g., a laser source, at least one movable optical element, a scanning device, etc.) based on the read-out sensor data.

For selecting the at least one hyperspectral pixel, the control device may be configured to sense a user input (e.g., on a touch screen or via a mouse or cursor) corresponding to an area of the image of the machining area and to determine or select at least one hyperspectral pixel corresponding to said image area. In other words, the selected image area may correspond to one hyperspectral pixel or a plurality of hyperspectral pixels. Selecting the at least one hyperspectral pixel may also be referred to as activating the at least one hyperspectral pixel. Those pixels among the X × Y pixels that are associated with or are grouped within the at least one selected hyperspectral pixel are read out to monitor or control the laser machining process.

The user input or selection of the image area may occur prior to the laser machining process to be monitored. For example, in a first step, a (full) image of the machining area may be captured. In a second step, a user input to select at least one image area may be performed, e.g., by marking the area in the (full) image (e.g., using a mouse, a cursor, or a touch input). In a third step, one or more hyperspectral pixels corresponding to the at least one image area may be selected. In a fourth step, which may be performed repeatedly or continuously during the laser machining process, the pixels of the selected hyperspectral pixel(s) may be read out. The read-out pixel data or sensor data may be used during the laser machining process to perform closed-loop or open-loop control the laser machining process. The read-out pixel data or sensor data may be used during the laser machining process and/or after the laser machining process has ended to monitor and, if necessary, to classify the laser machining process.

Each of the pixels may correspond to a photosensor of the image sensor. A photosensor may be formed by or comprise a photodiode. The image sensor may comprise a two-dimensional array of X × Y photosensors corresponding to the X × Y pixels. Here, X may indicate the number of pixels or photosensors along an x-direction, and Y may indicate the number of pixels or photosensors along a y-direction. The x-direction and the y-direction may be perpendicular to one another. The image sensor may, for example, comprise an array of X × Y=512 × 640 (VGA resolution) photosensors or pixels. Each of the pixels or photosensors may have the same spectral sensitivity range.

A width of the spectral sensitivity range (also referred to as "spectral sensitivity") of the pixels or photosensors may be 500 nm or more, in particular 750 nm or more. The spectral sensitivity range of the photosensors may lie within a range of 200 nm to 2000 nm or within a range of 350 nm to 2000 nm, in particular within a range of 400 nm to 2000 nm.

Reading out a pixel may mean that a radiation intensity sensed by the pixel is read out and, if necessary, converted into a corresponding, in particular digital, sensor value. The read-out sensor data may comprise the sensed radiation intensities or the sensor values of the corresponding pixels.

The mosaic filter may be an optical filter. The mosaic filter may comprise a plurality of individual filters. The mosaic filter may have a regular structure and/or may comprise individual filters arranged iteratively corresponding to the X × Y pixels or photosensors. One individual filter may be provided per pixel or per photosensor. The image sensor may be formed integrally with the pixels and the mosaic filter. The pixels and the mosaic filter may be formed together on a substrate of the image sensor. The mosaic filter may be formed as one or more layers over the pixels or photosensors formed on the substrate. The individual filters of the mosaic filter may have a total of k × l, in particular k × l=2 × 2=4 or k × l=4 × 4=16 or k × l=5 × 5=25, different, in particular non-overlapping, transmission wavelength ranges. The number of transmission wavelength ranges may correspond to the number of pixels in a hyperspectral pixel. In this case, each pixel of a hyperspectral pixel may capture a different wavelength range.

The mosaic filter may group the X × Y pixels into N hyperspectral pixels such that each of the N hyperspectral pixels has the same structure, in particular consists of the same number of pixels. The mosaic filter may have a grid structure, wherein each grid cell has the same arrangement of at least partially different individual filters. An individual filter may be assigned to each pixel, such that light from this pixel is sensed only in a wavelength range corresponding to the individual filter. The pixels assigned to a grid cell may form the hyperspectral pixel. In other words, the pixels of a hyperspectral pixel may be configured to sense radiation intensity in at least two different wavelength ranges.

The k × l transmission wavelength ranges of the individual filters of the mosaic filter may completely and/or uniformly divide the spectral sensitivity range of the pixels or photosensors. The k × l transmission wavelength ranges may each adjoin another or be immediately subsequent. The k × l transmission wavelength ranges may be of equal size. For example, when the spectral sensitivity range of the photosensors is 200 nm to 2000 nm, k × l=4 × 4=16 non-overlapping transmission wavelength ranges may divide the spectral sensitivity range into 16 non-overlapping transmission wavelength ranges, each adjacent to the next, with a width of (2000 nm – 200 nm)/16 = 112.5 nm. In this case, a hyperspectral pixel may comprise at least 16 pixels. The transmission wavelength ranges may also vary in size. In particular, the transmission wavelength ranges may be wider the longer the wavelength of the range (with the possible exception of the laser back reflection—this range may be selected to be small, e.g., with a width of 10 nm–20 nm). The wavelength ranges may be unevenly distributed across the entire spectral sensitivity range and/or overlapping and/or non-adjacent to one another, i.e., there may also be "holes" (unmonitored spectral ranges) within the measurement range.

All hyperspectral pixels may have an identical structure. Each hyperspectral pixel may consist of the same number of pixels. The image sensor may be configured to sense and/or read out, for the pixels of each hyperspectral pixel, radiation intensity, in particular the process radiation of the laser machining process and/or radiation from additional illumination (e.g., from an illumination laser), in at least two different wavelength ranges. The two different wavelength ranges may be non-overlapping.

A hyperspectral pixel may comprise m pixels, i.e., m may indicate the number of pixels in a hyperspectral pixel. The number m of pixels in a hyperspectral pixel may be greater than or equal to the number k × l of different transmission wavelength ranges of the mosaic filter. When m = k × l, k may indicate the number of pixels in the x-direction and l the number of pixels in the y-direction, wherein k and l may be equal or different from one another. A hyperspectral pixel may comprise four by four pixels, i.e., m = 16 pixels (k = 4, l = 4). The image sensor may be configured to sense radiation intensity in 16 different wavelength bands per hyperspectral pixel. A hyperspectral pixel may comprise 5 × 5 pixels, i.e., m=25 pixels (k=5, l=5). The image sensor may be configured to sense radiation intensity in 25 different wavelength ranges per hyperspectral pixel.

The control device may be configured to read out all pixels of the at least one selected hyperspectral pixel at a resulting readout frequency of fᵤ=(X × Y × f₀)/u. Here, u may be the total number of pixels of all selected hyperspectral pixels, and f₀ may be the nominal readout frequency of the image sensor for reading out X × Y pixels. The nominal readout frequency may, for example, be specified by the model of the image sensor used and/or the manufacturer of the image sensor. The nominal readout frequency may specify a maximum frequency of the image sensor at which all X × Y pixels or photosensors of the image sensor can be read out per readout operation. These calculations apply in particular to a maximum achievable theoretical upper limit. Depending on the sensor and the physical readout channels, the frame rate may reach a lower value.

The resulting readout frequency may be greater than the nominal readout frequency. In embodiments, the resulting readout frequency may be greater than or equal to 40 kHz, or 100 kHz. For an image sensor with X × Y=640 × 512 pixels (VGA resolution) and a nominal readout frequency of f₀ = 400 Hz, with 16 image regions selected, each with one hyperspectral pixel, in turn each having 16 pixels (m=k × l=4 × 4), u = 16 × 1 × 16 = 256 and the resulting readout frequency fᵤ = (640 × 512 × 400 Hz)/256 = 512 kHz. The same resulting readout frequency fᵤ = 512 kHz is obtained when selecting an image area with 16 hyperspectral pixels, each comprising 16 pixels.

For an image sensor with X × Y=640 × 512 pixels (VGA resolution) and a nominal readout frequency of f₀ = 400 Hz, with 16 image regions selected, each with four hyperspectral pixels, each of which having 16 pixels, u = 16 × 4 × 16 = 1024 and the resulting readout frequency fᵤ = (640 × 512 × 400 Hz)/1024 = 128 kHz.

The control device may be configured to read out the pixels of all selected hyperspectral pixels from the image sensor as a snapshot or in a snapshot mode. In other words, the entire data set, i.e., the sensor data of all pixels of all selected hyperspectral pixels, may be provided to the control device with a single output from the image sensor and/or in a single readout operation.

The control device may be configured to switch between a monitoring mode, in which only the pixels of the at least one hyperspectral pixel corresponding to the at least one selected image region are read out, and a full-image mode, in which all X × Y pixels are read out. An image comprising all X × Y pixels may also be referred to as a full image. The full-image mode provides higher spatial resolution at a lower readout frequency, namely at the nominal readout frequency, while the monitoring mode provides a higher resulting readout frequency limited to the at least one image area. This enables both rapid or efficient monitoring and complete monitoring.

The laser machining system or the laser machining head may comprise a scanning device for deflecting the laser beam onto the workpiece. The control device may be configured to switch, depending on a laser beam position of the scanning device, between at least two different sets, each comprising at least one selected image area. The laser machining head may comprise the scanning device for the laser beam. The scanning device may be configured to move and/or deflect the laser beam relative to the surface of the workpiece.

The control device and/or the control unit may comprise a neural processing unit ("NPU"). The control device and/or the control unit may be configured to process the read-out sensor data of the pixels of the at least one selected hyperspectral pixel as raw data and/or without preprocessing by a transfer function to obtain output data. The control device and/or the control unit may be configured to monitor or control the laser machining process based on the obtained output data. In other words, the read-out sensor data may be used (directly or immediately) as input data for the transfer function. Processing using the transfer function may be performed continuously and/or in real time during the laser machining process. The transfer function may be formed by a neural network and/or an artificial intelligence model and/or a machine learning model. Processing using the transfer function may also be referred to as inference and/or may be performed by the neural processor. The processor may also be included in a computing device separate from the control device.

The control device may be configured to read out an image with X × Y pixels from the image sensor (i.e., with all pixels of the image sensor) and/or with all pixels of the image sensor that are configured to sense radiation intensity in a predetermined wavelength range.

The control device may be configured to determine a degree of contamination of an optical element and/or a component of the laser machining head by evaluating an intensity of a laser back reflection and/or by evaluating an image under additional illumination and/or by evaluating an imaging contrast based on the read-out sensor data. The additional illumination may be provided by an illumination laser or LED lighting.

The control device may be configured to determine a focal position of the laser machining head and/or a deviation from the focal position and/or the temperature of an optical element and/or the temperature of a component of the laser machining head by evaluating an imaging contrast and/or by evaluating color blur in the read-out sensor data.

The monitoring device may be arranged on the laser machining head, in particular on a housing of the laser machining head, or may be attached thereto. The optical path of the image sensor may extend at least in part coaxially with the optical path of the laser beam.

The machining area may be an area on or at the workpiece that comprises the TCP and/or the point of incidence of the laser beam on the workpiece and/or the keyhole. The machining area may further comprise a melt pool.

The method may further comprise displaying an image of the machining area on a display device and selecting the at least one image area based on the displayed image by a user. The displayed image may be a full image of the machining area. Accordingly, an image area of the full image of the machining area may be selected. The full image may comprise an image of the machining area and, optionally, also a vicinity of the machining area. The full image may be captured prior to the start of the laser machining process.

The process radiation may comprise optical radiation in the visible wavelength range and/or optical radiation in the infrared wavelength range and/or optical radiation in the back-reflection wavelength range (laser back reflection).

The term "visible wavelength range" refers to a wavelength range that predominantly comprises wavelengths in the visible spectrum of light. In particular, the visible wavelength range may be or include a wavelength range between 350 nm and 850 nm, or between 390 nm and 850 nm, or between 380 nm and 800 nm.

The term "infrared wavelength range" refers to a wavelength range that includes wavelengths in the infrared spectral range. In particular, the infrared wavelength range may be or include a wavelength range greater than 1200 nm, specifically between 1200 nm and 2000 nm.

The term "back-reflection wavelength range" refers to a wavelength range that includes the wavelength of the laser beam, which, for example, is between 1000 nm and 1100 nm.

The term "non-overlapping" wavelength ranges means that no wavelength from one wavelength range is contained within any of the other wavelength ranges (i.e., not measurable or with a relative intensity of less than 1%). "Non-overlapping" is synonymous with "completely distinct from one another."

Monitoring the laser machining process may comprise observing the laser machining process, evaluating the laser machining process, and/or detecting machining errors, and/or classifying machining errors, and/or classifying a machining result of the laser machining process, for example, by predicting a physical quantity of the process. Monitoring and/or controlling may be performed in real time and/or during the laser machining process. In the case of real-time monitoring, the term "online monitoring" may also be used.

The laser machining system and/or the monitoring device, in particular the control device, according to aspects and embodiments of the present disclosure may be configured to perform methods of monitoring according to aspects and embodiments of the present disclosure. Conversely, the method of monitoring according to aspects and embodiments of the present disclosure may be performed by the laser machining system and/or the monitoring device, in particular the control device, according to aspects and embodiments of the present disclosure.

The laser machining process may be a laser printing process, a laser ablation process, a laser soldering process, a laser cladding process (additive manufacturing), a laser welding process, or a laser cutting process. The workpiece may be a metallic workpiece, in particular sheet metal.

### BRIEF DESCRIPTION OF THE FIGURES

Hereinafter, embodiments of the present disclosure are described based on figures. In the figures:

FIG. 1 shows a laser machining system according to embodiments of the present disclosure;

FIG. 2 shows a schematic top view of the image sensor according to embodiments of the present disclosure;

FIG. 3 shows a schematic view of an image captured by an image sensor according to embodiments of the present disclosure;

FIG. 4 shows a flowchart of a method of monitoring a laser machining process;

FIG. 5 shows a flowchart of an embodiment of the method of monitoring a laser machining process.

### DETAILED DESCRIPTION

Corresponding elements and dimensions are always designated by the same reference symbols in all figures. Unless otherwise noted, the same reference symbols are used hereinafter for identical and functionally equivalent elements. Redundant descriptions of recurring features are avoided. The various embodiments and features of the figures described below may be explicitly combined and should not be understood as self-contained embodiments.

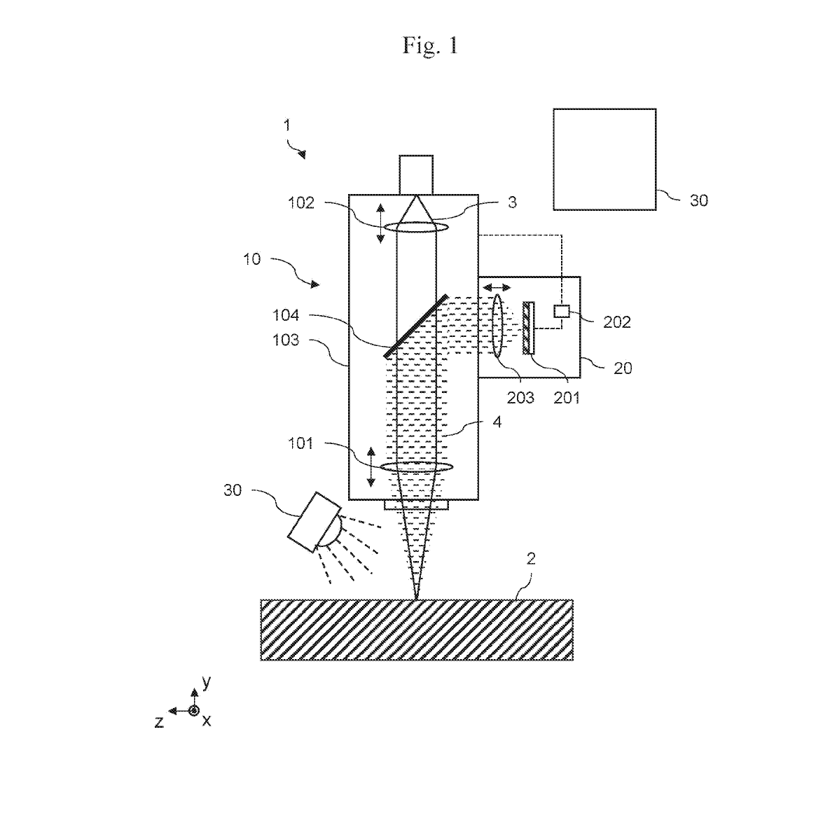

FIG. 1 shows a laser machining system according to embodiments of the present disclosure.

The laser machining system 1 comprises a laser machining head 10, a monitoring device 20 according to embodiments of the present disclosure, and a control unit 30. The laser machining system 1 is configured to perform a laser machining process on at least one workpiece 2 by a laser beam 3.

During the laser machining process, the laser beam 3 is directed onto the workpiece 2 by the laser machining head 10, causing the material of the workpiece 2 to heat up, melt, and, optionally, vaporize. This allows a laser cutting process or laser welding process to be performed on the workpiece 2.

Process radiation 4 is generated during the laser machining process. The process radiation 4 comprises the laser radiation backscattered or reflected by the workpiece 2 (so-called laser back reflection), radiation generated in the (near-)infrared wavelength range of light, e.g., including thermal radiation from a melt pool (not shown), and radiation generated in the visible wavelength range of light, e.g., including radiation from a plasma generated during machining. Furthermore, radiation from an additional illumination 30 of the laser machining system for illuminating the surface of the workpiece 2 may get from the workpiece 2 to the monitoring device 20. The additional illumination 30 may, for example, be configured as an illumination laser.

The laser machining head 10, which may, for example, be configured as a laser cutting head or a laser welding head, is configured not only to direct the laser beam 3 onto the workpiece 2 but also to shape the laser beam 3. The laser machining head 10 comprises optics for beam guidance and shaping, such as lenses, objectives, mirrors, prisms, axicons, etc. Shown is a focusing lens 101 for focusing the laser beam 3 onto the workpiece 2. The laser machining head 10 further comprises, for example, a collimating lens 102 for collimating the laser beam 3. The laser machining head 10 may comprise further optics and components not shown, such as apertures. For example, the laser machining head 10 may include a scanning device for deflecting the laser beam 3 onto the workpiece 2.

In addition, the laser machining system 1 may include a laser source (not shown) for generating the laser beam 3. The laser beam 3 may be fed to the laser machining head 10 via an optical fiber (also not shown). Furthermore, a displacing device (not shown) configured to adjust a position of the laser machining head 10 relative to the workpiece 2, in particular to move the laser machining head 10 along a feed direction, may be provided. In FIG. 1, for example, the feed direction may be in a plane defined by the z-direction and the x-direction of a Cartesian coordinate system. The workpiece 2 or workpieces may be configured as a plate-shaped and/or metallic workpiece.

The laser machining head 10 comprises a housing 103 in which the optics and components are received. The monitoring device 20 may be arranged on an outer surface of the housing 103. A beam path of the monitoring device may, as in the example of a laser machining system shown in FIG. 1, extend partially through the laser machining head 10 or coaxially with a beam path of the laser beam 3. In this example, the process radiation 4 generated during the laser machining process or the radiation caused by the additional illumination 30 enters the housing of the laser machining head 10, is deflected from the beam path of the laser beam 3 by a beam splitter 104 of the laser machining head 10, and subsequently enters the monitoring device 20. The beam splitter 104 may, for example, be configured as a dichroic mirror.

The monitoring device 20 comprises an image sensor 201 for capturing an image of the workpiece, in particular the workpiece surface, by spatially resolving the incident radiation intensity. The monitoring device 20 may include one or more focusing lenses 203 to focus the process radiation 4 onto a sensor plane of the image sensor 201.

The image sensor 201 is in particular configured to capture images of the machining area of the laser machining process on or at the workpiece 2, as described in detail later. The image sensor comprises an array of X × Y pixels and a mosaic filter, wherein the X × Y pixels are grouped into N hyperspectral pixels by the mosaic filter.

The monitoring device 20 is configured to monitor the laser machining process. The monitoring device 20 comprises a control device 202. The control device 202 may be integrated into the control unit 30 of the laser machining system 1 or be part of the control unit 30. The control device 202 is configured to monitor the laser machining process based on sensor data from the image sensor 201. Based on a user input for at least one selected image area, the control device 202 selects at least one hyperspectral pixel HP corresponding to the selected image area. The control device 202 then reads out all pixels of the at least one selected hyperspectral pixel. Based on the read-out sensor data corresponding to the at least one selected image area, the control device 202 monitors the laser machining process.

The control device 202 may be connected to elements of the laser machining head 10 and other elements of the laser machining system 1 in order to control them. Accordingly, the control device 202 may be configured to perform closed-loop control of the laser machining process. Functions of the control device 202, such as the closed-loop control function, may be offloaded to other control or computing devices (not shown) of the laser machining system 1.

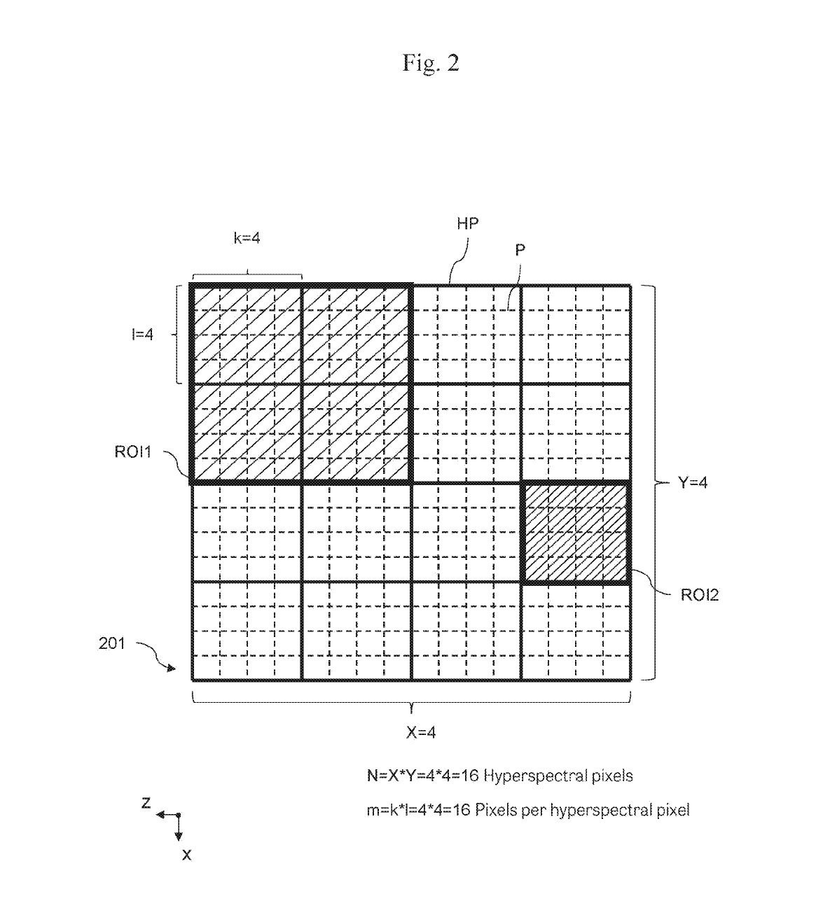

FIG. 2 shows a schematic top view of the image sensor according to embodiments of the present disclosure to illustrate the arrangement of pixels and the hyperspectral pixels.

The image sensor 201 comprises an array of X × Y pixels P. Each pixel P may, for example, correspond to a (single) photosensor, such as a photodiode, of the image sensor 201. Thus, the image sensor 201 comprises a two-dimensional array of X × Y pixels or photosensors, which are arranged side by side in the x-y plane as shown. In the example shown in FIG. 2, the image sensor 201 comprises 16 pixels P along the x-direction and 16 pixels P along the y-direction. In total, the image sensor 201 thus comprises N=16 × 16=256 pixels P.

The image sensor 201 further comprises the optical mosaic filter (not shown) having a regular and repeating arrangement of individual filters, wherein each individual filter corresponds to a pixel or photosensor. The mosaic filter thus comprises, for example, 256 individual filters. All individual filters comprise k × l different transmission wavelength ranges that can completely and uniformly divide the spectral sensitivity range of the photosensors. Groups of k × l individual filters arranged side by side with different transmission wavelength ranges are arranged side by side in the x and y directions. In the example shown, k=4 and l=4. Using the mosaic filter, the pixels P are grouped into hyperspectral pixels HP. As shown, a hyperspectral pixel comprises m=k × l=4 × 4=16 pixels P. All hyperspectral pixels HP have an identical structure. Thus, using a hyperspectral pixel HP, the radiation intensity emitted by the workpiece or the machining area may be detected with wavelength resolution across m=16 different wavelength ranges, corresponding to the 16 different transmission wavelength ranges. Because the image sensor 201 includes a plurality of hyperspectral pixels HP, the radiation intensity may also be detected with spatial resolution. In total, the image sensor 201 includes N=16 hyperspectral pixels, i.e., the 256 pixels are grouped into N=16 hyperspectral pixels.

Via user input, one or more image areas of the image of the workpiece or the machining area captured by the image sensor 201 may be selected. An image area in the image corresponds to an area on the workpiece that is relevant or of interest for monitoring the laser machining process or for detecting machining errors, for example a subarea of the machining area or a vicinity of the machining area. The selection of the image area may be performed before the laser machining process and/or during a pause in the laser machining process when the laser beam is switched off.

FIG. 2 shows two selected image areas ("Region of Interest," abbreviated "ROI"), ROI1 and ROI2. The selected image area ROI1 comprises 4 hyperspectral pixels HP, and the selected image area ROI2 comprises 1 hyperspectral pixel HP. The control device selects the hyperspectral pixels HP corresponding to the selected image areas ROI1 and ROI2 for monitoring the laser machining process, reads out all pixels P of the selected hyperspectral pixels HP, and monitors the laser machining process based on the sensor data read out in this manner.

For example, the nominal readout frequency of the image sensor 201, for reading out images with all N=X × Y=256 pixels, is f₀=400 Hz. When the control device 201 selects, for example, the four hyperspectral pixels HP of the image area ROI1 and the single hyperspectral pixel HP of the image area ROI2, the total number of pixels of all selected hyperspectral pixels HP is u=5 × 16=80. Accordingly, the control device may be configured to read out all pixels P of the five selected hyperspectral pixels HP from the image sensor 201 at a maximum resulting readout frequency of fᵤ=(X × Y × f₀)/u = (256 × 400 Hz)/80=1280 Hz. Thus, the (maximum) resulting readout frequency is 3.2 times higher than the nominal readout frequency, i.e., when all pixels of the image sensor are to be read out.

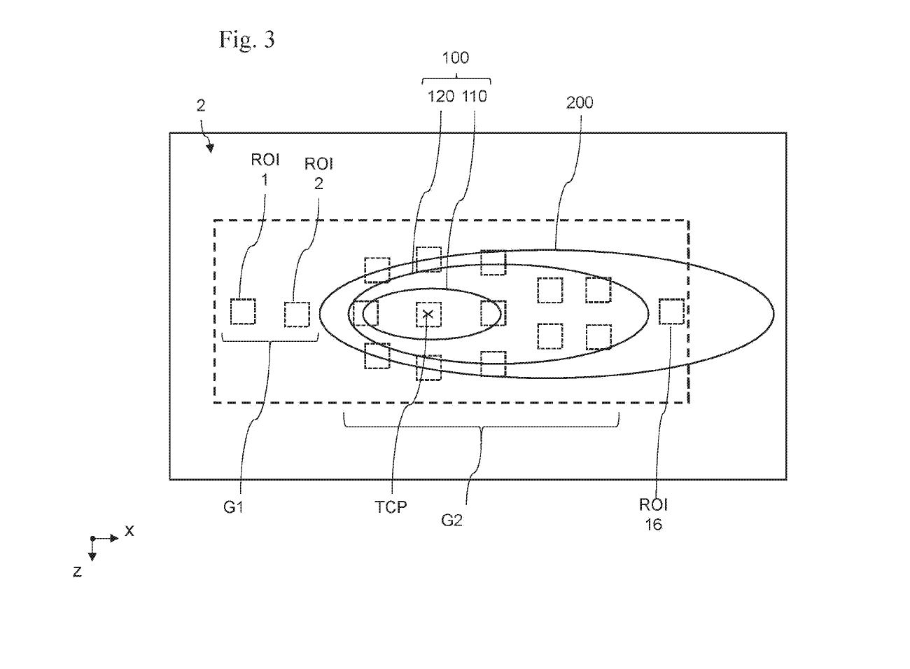

FIG. 3 shows a schematic view of an image captured by an image sensor according to embodiments of the present disclosure to illustrate image areas, hyperspectral pixels, and the machining area.

The image shows the machining area 100 on workpiece 2 during a laser welding process. A feed direction of the laser welding process extends along the z-direction. The machining area 100 comprises the keyhole 110 with the TCP and a melt pool 120 surrounding the keyhole 110, consisting of the molten material of workpiece 2. The machining area 100 and the melt pool 120 are surrounded by an area 200 in which the material of workpiece 2 is heated but not yet molten or has already solidified again. The image thus shows the machining area 100 and the vicinity thereof.

FIG. 3 also illustrates a plurality of selected image areas ROI1, ROI2, … ROI16, which have been selected for monitoring the laser machining process. The control device has selected a total of 16 hyperspectral pixels HP (1 HP per ROI) corresponding to these image areas. Among these 16 image areas, there is a first group G1 of two image areas that lie upstream of the keyhole 110 and the machining area 100 in the image, respectively. There is also a second group G2 of 13 image areas that lie entirely or at least partially within the machining area 100. Furthermore, there is a third group comprising only a single image area, ROI16, which lies in the image downstream of the machining area 100. According to the present disclosure, rapid combined readout of the pixels is made possible, thereby allowing the replacement of the use of 16x16 individual diodes which, on the one hand, cannot be placed arbitrarily and, on the other hand, cannot generate a complete image.

By measuring and/or comparing the intensities of two (spatially and/or spectrally) adjacent pixels that sense wavelength ranges in the NIR region and are arranged upstream and/or downstream, the actual temperature upstream or downstream of the process can be determined based on the ratio of these radiation intensities. For example, a ratio of the intensities of the pixels may be determined to provide information about temperature changes in the workpiece upstream and downstream.

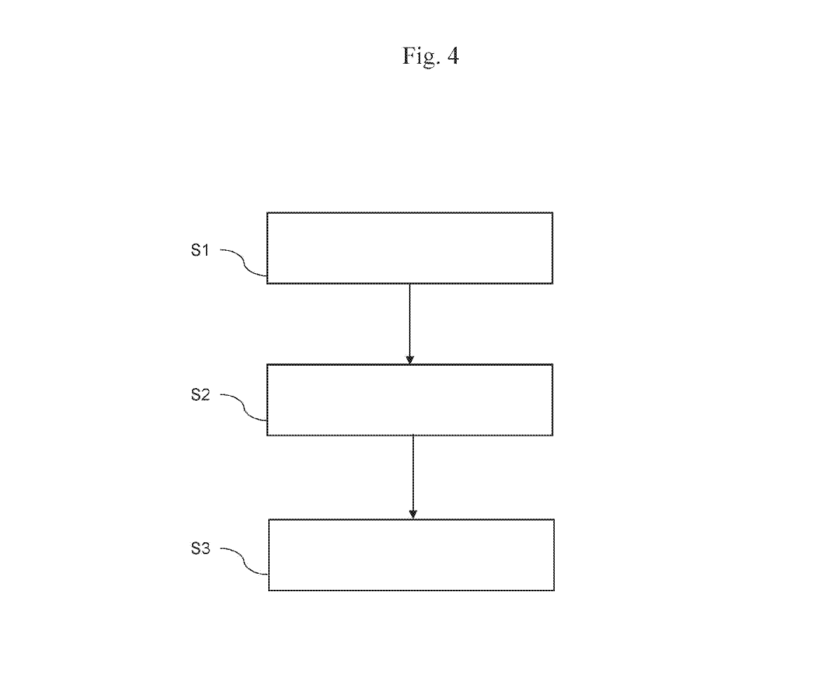

FIG. 4 shows a flowchart of a method of monitoring a laser machining process for machining a workpiece using a laser beam. The method may be carried out by a monitoring device according to embodiments of the present disclosure.

The method comprises the following steps: First, at least one hyperspectral pixel is selected based on a user input for at least one selected image area (Step S1). Subsequently, all pixels of the at least one selected hyperspectral pixel are read out from the image sensor (Step S2). Finally, the laser machining process is monitored and, optionally, controlled based on the read-out sensor data corresponding to the at least one selected image area (Step S3).

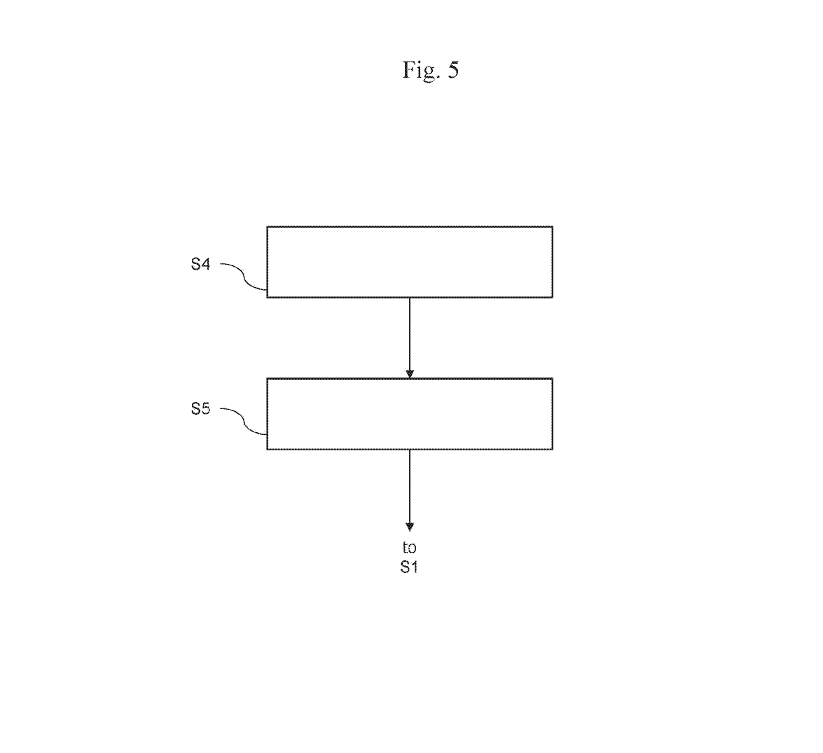

FIG. 5 shows a flowchart of additional optional steps of the method described in FIG. 4. The method may further comprise displaying an image of the machining area on a display device of the laser machining system (step S4) and selecting the at least one image area based on the displayed image by a user (step S5). Steps S4 and S5 may be performed prior to step S1 or may be performed before the start of the laser machining process.

According to further embodiments, the monitoring device or the control device may be configured for one or more additional monitoring functions, for example, for monitoring the temperature of an optical element (e.g., a focusing lens) or a component of the laser machining head, and/or for monitoring the degree of contamination of an optical element or a component of the laser machining head, and/or for monitoring the focal position of the laser beam. In embodiments, these monitoring functions are performed before and/or after the laser machining process.

For one or more of these monitoring functions, the monitoring device or the control device may be configured to read out sensor data from all X × Y pixels of the image sensor and/or sensor data from radiation in a specific wavelength range, i.e., sensor data from pixels of the image sensor configured to sense intensity in this specific wavelength range.

Furthermore, the monitoring device or the control device may be configured to determine, by evaluating the read-out sensor data, an intensity of a laser back reflection and/or an intensity of the additional illumination and/or an imaging contrast, in order to therefrom determine a degree of transparency or a degree of contamination of an optical element, for example the lens or a protective glass, and/or a component, such as an aperture, of the laser machining head.

Furthermore, the monitoring device or the control device may be configured to determine, by evaluating the read-out sensor data, a color blur and/or an imaging contrast, in order to thereby determine the focal position of the laser beam.

Thus, the degree of contamination of a component or optical element and the focal position or a focal position deviation of the laser beam may be determined and monitored. This may be accomplished by acquiring a contrast value and an intensity. For example, this may be done via a windowed calculation (Iₘₐₓ – I ₘᵢₙ)/(Iₘₐₓ + Iₘᵢₙ), followed by taking the mean.

The contrast value may be obtained by the control device switching to the selection of the image with all X × Y pixels (full frame) and then determining the total contrast based on the read.-out sensor data. These steps may, for example, be performed before the start of the laser machining process. Subsequently, the system switches to the selection of the at least one selected image area, and the laser machining process is carried out. The determined value for the overall contrast correlates with the contamination of, for example, the protective glass of the laser machining head. The contrast value may be fed to an NPU along with the intensities sensed during the laser machining process for the at least one selected image area. Alternatively or additionally, the degree of contamination may be determined using a model for determining the contamination. Thus, the degree of contamination of the protective glass may be determined and monitored.

The focal position or focal position deviation of the laser beam may be determined based on a surface calculation and a subsequent determination of image sharpness or defocusing based on the acquired sensor data. In addition, the machining area on the workpiece may be illuminated using the additional illumination of the laser machining system. The relationship between the calculated surface value and the focal position or focal position deviation may be derived from a regression model. The values determined in this way may also be fed to an NPU for monitoring. The determination of the focal position deviation may alternatively or additionally be performed using a convolutional neural network ("CNN"), e.g., Mobilenet V3.

Another way of determining and monitoring the focal position deviation or the focal position utilizes color blur. In this way, an object, such as the workpiece, is imaged with varying degrees of sharpness in each color channel (i.e., in different wavelength ranges or at different wavelengths) through the optics of the laser machining head and/or the monitoring device. The focal position may be determined directly from said differences in sharpness.

The temperature of a component and/or optical element of the laser machining head may also be determined and monitored. When the image sensor is focused (e.g., using the focusing lens in the monitoring device) on the focusing lens of the machining laser, the temperature or temperature change of the focusing lens may be determined via the radiation intensity in the wavelength range ≥ 1100 nm. By measuring the radiation intensity in the wavelength range ≥ 1100 nm before and/or after the laser machining process, a temperature change in a component and/or optical element of the laser machining head may be determined. The intensity values before and after the laser machining process may be compared to determine the temperature of the component and/or optical element after the laser machining process relative to the temperature thereof before the laser machining process (relative temperature or relative temperature change). For this determination, all pixels of the image sensor with a wavelength range exceeding 1100 nm onto which the component and/or optics are imaged may be selected.

From the read-out sensor data, a relative intensity in the NIR range (particularly at >1100 nm) can be determined as an average across the pixels used, optionally averaged over a period of 2 ms. For example, the intensity of all pixels sensitive in the NIR range onto which the component is imaged may be used for averaging. When a component of the machining head, e.g., the vignetting of an aperture, is located in the field of view of the image sensor or the monitoring device, the temperature of this aperture may be determined and monitored via radiation thermometry since the wavelength range from >1100 nm to, for example, 2000 nm is available.

Furthermore, intensities of (spatially and/or spectrally) adjacent pixels with wavelength ranges in the NIR range may be sensed to determine absolute temperatures via a ratio measurement. The adjacent pixels may be pixels of the same hyperspectral pixel and/or be immediately adjacent to one another. The adjacent pixels may be sensitive to wavelength ranges that are adjoining or spaced less than 30 nm apart. The distance between two wavelength ranges generally refers to the spectral distance between the maximum wavelength of the wavelength range comprising the shorter-wavelength range of the two wavelength ranges and the minimum wavelength of the other wavelength range.

Monitoring the laser machining process according to embodiments of the present disclosure also has the following technical effects and aspects: When the laser beam is deflected from the TCP (for example, by a scanning device of the laser machining head), this may lead to a change in the imaging due to lens errors and to an attenuation of the intensity of the laser back reflection. While with photodiode-based solutions, only an intensity offset is observed, the present solution, which uses optical imaging onto the image sensor, has the aspect of making changes in the imaging visible.

For example, a change in the melt pool geometry due to spherical aberration or a change in the intensity distribution across the object surface may be detected, and a correlation with the beam deflection on the workpiece may be established.

Using calibration workpieces, the image may be corrected to compensate for the laser beam deflection, or the laser beam deflection may be determined based on the distortion of the image. This can be done using a model generated via machine learning.

The chromatic aberration in the scan field leads, in particular when the laser beam is deflected from a zero position, to a splitting of the radiation incident on the image sensor and to a shift or different imaging in the image. The imaging of the different wavelengths becomes visible with the image sensor 202, which may be regarded as a hyperspectral sensor. The correlation with the beam deflection in the scan field may be used for scan field position detection.

The freely selectable image areas may be switched between for different weld seams distributed across a large scan field. This ensures that the correct image of the machining area is always captured.

The present disclosure relates to a monitoring device and a method of monitoring and, optionally, assessing the quality and predicting relevant properties in laser machining processes. This desirably allows for high sampling frequencies and high spatial resolution. Frequencies of more than 40 kHz can be achieved. In addition, the entire process-relevant wavelength range from 400 to 2000 nm can be monitored. In laser machining processes (particularly laser welding), the process radiation of the laser machining process, which includes backscattered light from the laser beam, and radiation from an illumination laser may be imaged onto a sensor. The use of standardized camera interfaces enables easy integration into an evaluation system with an NPU, e.g., via CameraLink.

The spatial resolution also eliminates the otherwise necessary alignment of sensors or photodiodes to achieve good process imaging since overall a large-area capture range is possible, followed by the selection of specific spatial image areas or hyperspectral pixels. Furthermore, the integrated capability to monitor protective glass, temperature, and focal position may also significantly reduce system costs.

Examples of some embodiments of the present disclosure are described below. However, it should be noted that the embodiments of the present disclosure are not limited to these examples.

Appendix 1 A monitoring device (20) for monitoring a laser machining process, comprising:
an image sensor (201) for capturing an image of a machining area of said laser machining process, wherein said image sensor comprises an array of X × Y pixels (P) and a mosaic filter, wherein the X × Y pixels (P) are grouped into N hyperspectral pixels (HP) by said mosaic filter, and
a control device (202) for monitoring said laser machining process based on sensor data from said image sensor,
wherein said control device is configured to:
select at least one hyperspectral pixel (HP) based on a user input for at least one selected image area (ROI, ROI1, ROI2),
read out all pixels (P) of the at least one selected hyperspectral pixel (HP) from said image sensor as sensor data, and
monitor and/or control said laser machining process based on the read-out sensor data.

Appendix 2 The monitoring device according to appendix 1, wherein all pixels (P) have the same spectral sensitivity range.

Appendix 3 The monitoring device according to one of the preceding appendixes, wherein all hyperspectral pixels (HP) are structured identically, and/or
wherein each hyperspectral pixel (HP) consists of the same number of pixels (P), and/or
wherein the pixels (P) of a hyperspectral pixel (HP) are configured to sense radiation intensity in at least two different wavelength ranges.

Appendix 4 The monitoring device according to one of the preceding appendixes, wherein a hyperspectral pixel (HP) comprises at least 2 × 2, 3 × 3 or 4 × 4 or 5 × 5 pixels (P), and/or
wherein said image sensor (201) is configured to sense radiation intensity in at least 4, 9, 16, or 25 different wavelength ranges per hyperspectral pixel (HP).

Appendix 5 The monitoring device according to one of the preceding appendixes, wherein said control device (202) is configured to read out all pixels (P) of the at least one selected hyperspectral pixel (HP) from said image sensor (201) at a resulting readout frequency of fᵤ=(X × Y × f₀)/u,
where u is the number of pixels of all hyperspectral pixels (HP) of the at least one selected image area (ROI), and f₀ is the nominal readout frequency of said image sensor (201) to read out images with X × Y pixels.

Appendix 6 The monitoring device according to one of the preceding appendixes, wherein the resulting readout frequency when reading out the image sensor (201) is equal to or greater than 40 kHz, or equal to or greater than 100 kHz.

Appendix 7The monitoring device according to one of the preceding appendixes, wherein said control device (202) is configured to read out the pixels (P) of all selected hyperspectral pixels (HP) from said image sensor (201) in a snapshot mode.

Appendix 8 The monitoring device according to one of the preceding appendixes, wherein said control device (202) is configured to switch between a monitoring mode, in which the pixels (P) of the at least one selected hyperspectral pixel (HP) for the at least one selected image area (ROI) are read out, and a full-image mode, in which all X × Y pixels are read out.

Appendix 9 The monitoring device according to one of the preceding appendixes, wherein said control device comprises a neural processor, and/or
wherein said control device (202) is configured to process the read-out pixels (P) of the at least one selected hyperspectral pixel (HP) using a neural network as raw data and/or without preprocessing to obtain output data, and wherein said control device (202) is configured to monitor and/or control said laser machining process based on the obtained output data.

Appendix 10 A laser machining system (1) for performing a laser machining process on a workpiece (2) using a laser beam (3), said laser machining system comprising:
a laser machining head (10) for radiating the laser beam (3) onto the workpiece (2),
a control unit (30) for controlling said laser machining head (10), and a monitoring device (20) for monitoring the laser machining process according to one of the preceding appendixes.

Appendix 11 The laser machining system according to appendixes 10, further comprising:
a scanning device for deflecting the laser beam on the workpiece,
wherein said control device (202) is configured to switch between at least two sets, each comprising at least one selected image area (ROI), depending on a laser beam position of the scanning device.

Appendix 12 The laser machining system according to appendix 10 or 11, wherein said control unit (30) and/or said control device (202) of said monitoring device (20) is configured to determine, based on the read-out sensor data, an intensity of a laser back reflection and/or an imaging contrast in order to determine, based thereon, a degree of contamination of an optical element and/or a component of said laser machining head (10).

Appendix 13 The laser machining system according to appendix 10, 11, or 12, wherein said control unit (30) and/or said control device (202) of said monitoring device (20) is configured to determine, based on the read-out sensor data, an imaging contrast and/or color blur for determining a focal position of the laser beam (3) and/or a deviation from a predetermined focal position and/or a temperature of an optical element and/or a temperature of a component of said laser machining head (10).

Appendix 14 A method for monitoring a laser machining process using a monitoring device (20) comprising an image sensor (201) for capturing an image of a machining area of the laser machining process, wherein said image sensor (201) comprises an array of X × Y pixels (P) and a mosaic filter, wherein the X × Y pixels (P) are grouped into N hyperspectral pixels (HP) by said mosaic filter,
said method comprising the steps of:
selecting at least one hyperspectral pixel (HP) based on a user input for at least one selected image area (ROI),
reading out all pixels (P) of the at least one selected hyperspectral pixel (HP) as sensor data, and
monitoring and/or controlling the laser machining process based on the read-out sensor data.

Appendix 15 The method according to appendix 14, said method further comprising:
displaying an image of the machining area on a display device,
selecting at least one image area (ROI) in the image by a user.

1. A monitoring device for monitoring a laser machining process, comprising:
an image sensor for capturing an image of a machining area of the laser machining process, the image sensor comprises an array of X × Y pixels and a mosaic filter, wherein the X × Y pixels are grouped into N hyperspectral pixels by the mosaic filter, and
a control device for monitoring the laser machining process based on sensor data from said image sensor,
wherein the control device is configured to:
select at least one hyperspectral pixel based on a user input for at least one selected image area,
read out all pixels of the at least one selected hyperspectral pixel from the image sensor as sensor data, and
monitor and/or control the laser machining process based on the read-out sensor data.

2. The monitoring device according to claim 1, wherein all pixels have the same spectral sensitivity range.

3. The monitoring device according to claim 1, wherein all hyperspectral pixels are structured identically, and/or
wherein each hyperspectral pixel consists of the same number of pixels, and/or
wherein the pixels of a hyperspectral pixel are configured to sense radiation intensity in at least two different wavelength ranges.

4. The monitoring device according to claim 1, wherein a hyperspectral pixel comprises at least 2 × 2, and/or
wherein the image sensor is configured to sense radiation intensity in at least 4 different wavelength ranges per hyperspectral pixel.

5. The monitoring device according to claim 1, wherein the control device is configured to read out all pixels of the at least one selected hyperspectral pixel from the image sensor at a resulting readout frequency of fᵤ=(X × Y × f₀)/u,
where u is the number of pixels of all hyperspectral pixels of the at least one selected image area, and f₀ is the nominal readout frequency of said image sensor to read out images with X × Y pixels.

6. The monitoring device according to claim 5, wherein the resulting readout frequency when reading out the image sensor is equal to or greater than 40 kHz.

7. The monitoring device according to claim 1, wherein said control device is configured to read out the pixels of all selected hyperspectral pixels from the image sensor in a snapshot mode.

8. The monitoring device according to claim 1, wherein the control device is configured to switch between a monitoring mode, in which the pixels of the at least one selected hyperspectral pixel for the at least one selected image area are read out, and a full-image mode, in which all X × Y pixels are read out.

9. The monitoring device according to claim 1, wherein the control device comprises a neural processor, and/or
wherein the control device is configured to process the read-out pixels of the at least one selected hyperspectral pixel using a neural network as raw data and/or without preprocessing to obtain output data, and wherein the control device is configured to monitor and/or control the laser machining process based on the obtained output data.

10. A laser machining system for performing a laser machining process on a workpiece using a laser beam, the laser machining system comprising:
a laser machining head for radiating the laser beam onto the workpiece,
a control unit for controlling the laser machining head, and
a monitoring device for monitoring the laser machining process according to claim 1.

11. The laser machining system according to claim 10, further comprising:
a scanning device for deflecting the laser beam on the workpiece,
wherein the control device is configured to switch between at least two sets, each comprising at least one selected image area, depending on a laser beam position of the scanning device.

12. The laser machining system according to claim 10, wherein the control unit and/or the control device of the monitoring device is configured to determine, based on the read-out sensor data, an intensity of a laser back reflection and/or an imaging contrast in order to determine, based thereon, a degree of contamination of an optical element and/or a component of said laser machining head.

13. The laser machining system according to claim 10, wherein the control unit and/or the control device of the monitoring device is configured to determine, based on the read-out sensor data, an imaging contrast and/or color blur for determining a focal position of the laser beam and/or a deviation from a predetermined focal position and/or a temperature of an optical element and/or a temperature of a component of the laser machining head.

14. A method for monitoring a laser machining process using a monitoring device comprising an image sensor for capturing an image of a machining area of the laser machining process, wherein the image sensor comprises an array of X × Y pixels and a mosaic filter, wherein the X × Y pixels are grouped into N hyperspectral pixels by the mosaic filter,
the method comprising the steps of:
selecting at least one hyperspectral pixel based on a user input for at least one selected image area,
reading out all pixels of the at least one selected hyperspectral pixel as sensor data, and
monitoring and/or controlling the laser machining process based on the read-out sensor data.

15. The method according to claim 14, the method further comprising:
displaying an image of the machining area on a display device,
selecting at least one image area in the image by a user.
